(19) United States
(12) Patent Application Publication
(10) Pub. No.: US 2009/0061018 A1
(43) Pub. Date: Mar. 5, 2009

(54) Tooth brush sanitation methodology

(75) Inventor: Stuart W. DeJonge, DeLand, FL (US)

Correspondence Address: Stuart DeJonge, 804 Heron Point Circle, DeLand, FL, 32724-7342, US

(73) Assignee: DEJONGE ASSOCIATES, INC.

(21) Appl. No.: 11/897,347

(22) Filed: Aug. 30, 2007

(51) Int. Cl. A01N 31/02; A01N 31/08; A01N 33/12; A01N 37/00; A01N 43/40; A01N 47/44; A01N 59/00; A01P 1/00

(52) U.S. Cl. 424/616; 514/277; 514/558; 514/635; 514/642; 514/724; 514/731

(57) ABSTRACT

The methodology includes providing a portable, hand-held spray container to user for spraying a toothbrush with an effective amount of a solution containing: (a) water; (b) a flavoring additive; and, (c) about 0.5% to about 30% by weight of at least one antibacterial component. The antibacterial component may be selected from the group consisting of ethanol, denatured alcohol, thymol, hydrogen peroxide, peroxy acids and combinations thereof or it may be selected from the group consisting of a non-necrotic fatty acid compound, a bis-biquanido hexane, a quaternary ammonium salt, an N-tetradecyl pyridium salt and an N-tetradecyl ethyl pyridium salt and combinations thereof. The flavoring may be oil of peppermint, oil of spearmint, oil of clove, oil of wintergreen, oil of cinnamon, of oil of lemon, oil of almond, oil of nutmeg, oil of orange, oil of anise, oil of savory, oil of celery, oil of rosemary, oil of thyme, vanilla and combinations thereof.

### BACKGROUND OF INVENTION

a. Field of Invention

The invention relates generally to toothbrush cleaning and particularly a methodology for sanitizing toothbrushes.

b. Description of Related Art

The following patents are representative of methods of sanitizing articles:

U.S. Pat. No. 6,126,931 to Samuel P. Sawan et al describes a contact killing antimicrobial articles, devices and formulations are described which kill microorganisms on contact. The articles, devices or formulations contain a non-leaching antimicrobial material which is a unique combination of an organic matrix having biocidal metallic materials non-leachably associated with the matrix. The antimicrobial material may be used to form an antimicrobial coating or layer on a surface of the article or device, or may be dispersed in a vehicle or carrier to form a topical antiseptic or disinfectant, or solid shape having a contact killing antimicrobial properties. When a microorganism contacts the article, device, or formulation, the biocidal metallic material is transferred to the microorganism in amounts sufficient to kill it.

U.S. Pat. No. 5,849,311 to Samuel P. Sawan et al describes a antimicrobial material which can be used to form on the surface on a substrate a non-leaching antimicrobial coating layer which kills microorganisms on contact. The non-leaching antimicrobial coating or layer is a unique combination of an organic matrix immobilized on the surface of the substrate to having biocidal metallic materials non-leachably associated with the matrix. When a microorganism contacts the coating or layer, the biocidal metallic material is transferred to the microorganism in amounts sufficient to kill it.

U.S. Pat. No. 5,110,583 to Padmini Sampathkumar describes a method for treating or preventing anaerobe infections in humans and lower animals. This invention futher relates to compositions and kits containing peroxy acids useful for treating or preventing anaerobe infections according to the method of present invention.

U.S. Pat. No. 4,472,373 to Leslie D. Ryan describes oral compositions such as tooth pastes, mouthwashes, lozenges and chewing gum containing an antimicrobial agent which is effective against plaque/gingivitis and mouth odor are disclosed.

U.S. Pat. No. 4,224,307 to Geraldine H. Thiele et al. describes a mouthwash in a liquefied composition of an effective amount of a non-necrotic fatty acid compound prepared from an unsubstituted, unsaturated fatty acid having at least one double bond, water, an effective amount of a buffering agent, 1 to 10 percent of ethanol, and at least one oil soluble flavorant. The pH of the liquefied composition is between 9 and 11.

U.S. Pat. No. 4,080,411 to Abdul Gaffar et al describes an antibacterial oral composition effective to promote oral hygiene containing an antibacterial antiplaque agent and an additive which reduces staining of dental surfaces without substantially diminishing the antibacterial and antiplaque activity of the agent. Bis-biguanido hexanes, such as chlorhexidine and alexidine, and quaternary ammonium salts, such as benzethonium chloride and cetyl pyridinium chloride, are typical examples of antibacterial agents. The antistain additive is a bis (o-carboxyphenyl) ester of a C2-8 aliphatic dicarboxylic acid such as bis (carboxyphenyl) succinate.

Notwithstanding the prior art, the present invention is neither taught nor rendered obvious thereby.

### SUMMARY OF INVENTION

The present invention is directed to a methodology for sanitizing toothbrushes. The methodology includes spraying a toothbrush with an effective amount of a solution containing: (a) water; (b) a flavoring additive; and, (c) about 0.5% to about 30% by weight of at least one antibacterial component.

In some preferred embodiments of the present invention, the at least one antibacterial component is selected from the group consisting of ethanol, denatured alcohol, thymol, hydrogen peroxide, peroxy acids and combinations thereof. In some other preferred embodiments of the present invention, the at least one antibacterial component is selected from the group consisting of a non-necrotic fatty acid compound, a bis-biquanido hexane, a quaternary ammonium salt, an N-tetradecyl pyridium salt and an N-tetradecyl ethyl pyridium salt and combinations thereof. In other preferred embodiments of the present invention, the flavoring additive is selected from the group consisting of oil of peppermint, oil of spearmint, oil of clove, oil of wintergreen, oil of cinnamon and combinations thereof. In other preferred embodiments of the present invention, the flavoring additive is selected from the group consisting of oil of lemon, oil of almond, oil of nutmeg, oil of orange, oil of anise and combinations thereof. In yet other preferred embodiments of the present invention, the flavoring additive is selected from the group consisting of oil of savory, oil of celery, oil of rosemary, oil of thyme, vanilla and combinations thereof.

In some embodiments of the present invention, the flavoring additive may be selected from the group consisting of lime, banana, cherry, brandy, rum and combinations thereof.

In some embodiments of the present invention, the flavoring additive may be selected from the group consisting of butterscotch, imitation brandy, synthetic vanilla, synthetic flavor and combinations thereof.

In some preferred embodiments of the present invention, there is about 10% to about 25% of the antibacterial agent.

In some preferred embodiments of the present invention, there is about 0.02% to about 4% by weight of the flavoring additive.

The present invention is also directed to a methodology for sanitizing a toothbrush, which includes: (A.) providing a hand-held portable spray container, the spray container containing a solution comprising: (a) water; (b) a flavoring additive; and, (c) about 0.5% to about 30% by weight of at least one antibacterial component. (B.) spraying a toothbrush with an effective amount of the solution from the spray container. The particulars are the same as set forth above in the preceding paragraphs of this Summary section.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagram of preferred embodiments of the present invention methodology;

FIG. 2 is a block diagram of preferred antibacterial component choices for the present invention methodology; and,

FIG. 3 is a block diagram of preferred flavoring additives of the present invention methodology.

### DETAILED DESCRIPTION OF THE EMBODIMENTS

The present invention methodology involves sanitizing toothbrushes before use. Toothbrushes are considered by many dentists and other professionals to be a major cause of oral diseases and infections, due to their covert function as carriers and delivery systems of microbes and other bacteria that initiate these diseases and infections. Some proposed solutions to these problems include disposing of brushes frequently, utilizing antibacterial mouthwashes or even coating toothbrushes during manufacture to reduce anaerobic and bacterial activity.

While each of these proposals may be helpful, none deal with the immediacy of significant exposure to random carriers, such as large (non-nueroscopic) pieces of enemy-carrying debris, and some prior art methods are very risky, such as reliance upon toothbrush replacement.

The present invention solves these prior art problems by providing a portable, hand-held spray container for applying an effective amount of a sanitizing solution to a toothbrush anywhere, anytime, and especially immediately prior to each use of a toothbrush. This methodology is particularly beneficial for travelers and other situations where their brushes are not necessarily maintained in a clean environment.

The solutions are aqueous solutions, i.e. water or distilled water-based, and include a flavor additive and at least one active component, i.e., at least one antibacterial component. The antibacterial component is included in an amount of about 0.5% to about 30% by weight of the solution and preferably about 10% to about 25%. The flavor additive may be in any amount, understanding that the flavor additive is preferably strong enough to be a consumption deterrent. In other words, to discourage users from ingesting the solution. The preferred range of flavor additives is about 0.02% to about 4% by weight.

The balance of the solution is water. By “water” is meant H₂O and any other inert constituents with water that would not have any effect on the active component(s).

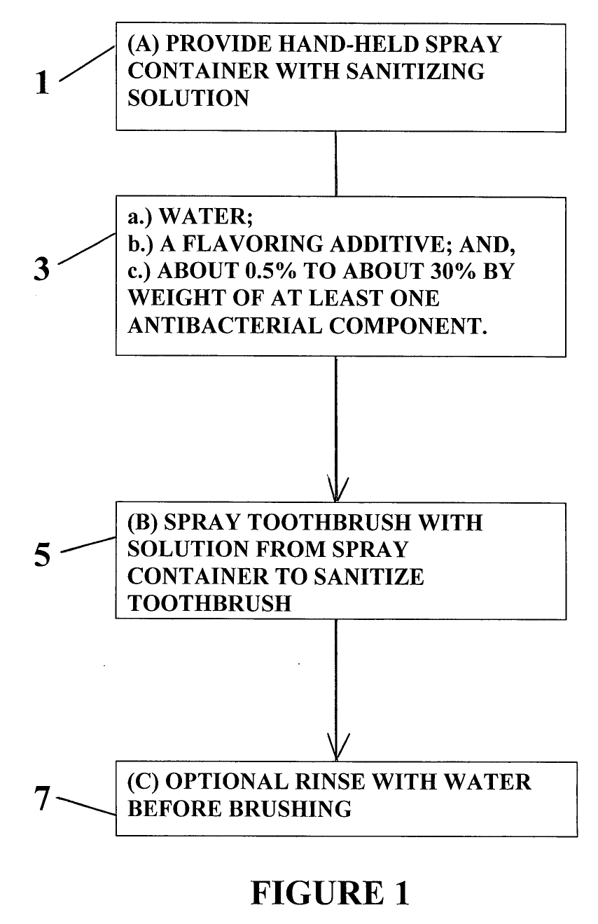

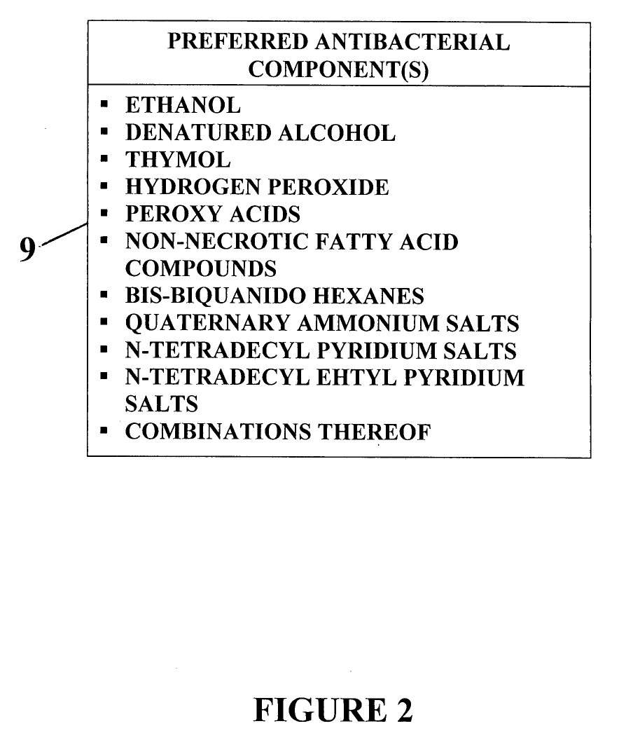

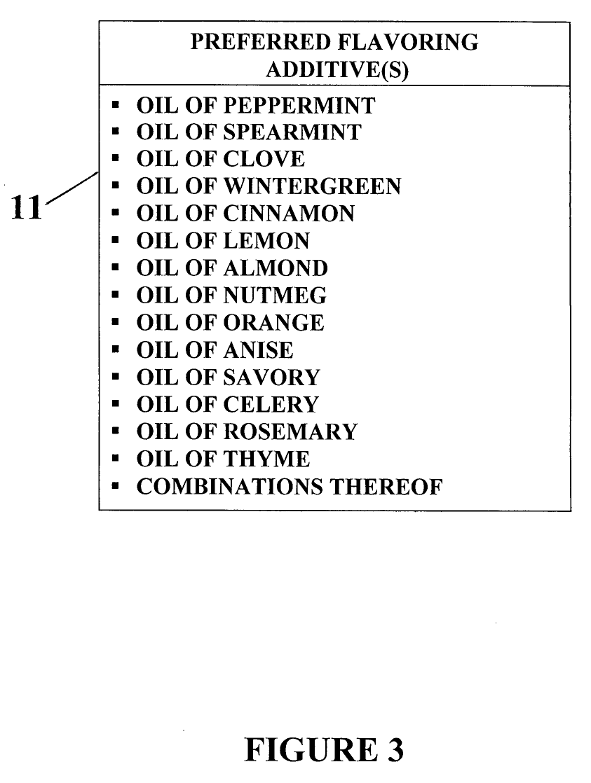

The methodology is shown in FIG. 1 in its preferred embodiments. Block 1 sets forth the first methodology step and block 3 illustrates the formula. Block 5 shows the second methodology step and block 7 indicates optional rinse before brushing. FIG. 2 shows the preferred antibacterial components in block 9. FIG. 3 shows preferred flavoring additives in block 11.

The pyridinium salt used in the present invention is either an N-tetradecylpyridinium salt or an N-tetradecyl-4-ethylpyridnium salt. These salts are known in the art as seen by U.S. Pat. No. 2,446,792, Aug. 10, 1948 to Shelton et al and U.S. Pat. No. 2,295,504, Sep. 8, 1942 to Shelton, both incorporated herein by reference. The N-tetradecylpyridinium salt can be represented as follows:

C-14-(pyridinium)+X⁻

wherein X⁻ is an acid ion constituent such as fluoride chloride, bromide, iodide, nitrate, acetate, phenylsulfonate among many others. The preferred ions are the fluoride, chloride, bromide and iodide with chloride being the most preferred.

The tetradecylpyridinium salt has the ethyl group at the “4” position on the ring and can be represented similarly:

C-14-(ethyl pyridinium)+X⁻

wherein X⁻ is defined above.

The flavorant can be a flavoring oil, and preferred are oil of peppermint, oil of spearmint, oil of clove, oil of lemon, oil of almond, oil of nutmeg, oil of orange, oil of wintergreen, oil of anise, oil of savory, oil of cinnamon, oil of celery, oil of rosemary and oil of thyme (the above are ethanol flavoring extracts). Other flavorants include vanilla, lime, banana, cherry, brandy, rum, butterscotch, imitation brandy and synthetic vanilla. Artificial and natural flavorants can be used.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A methodology for sanitizing a toothbrush, which comprises:
spraying a toothbrush with an effective amount of a solution containing:
(a) water;
(b) a flavoring additive; and,
(c) about 0.5% to about 30% by weight of at least one antibacterial component.

2. The methodology for sanitizing a toothbrush of claim 1, wherein said at least one antibacterial component is selected from the group consisting of ethanol, denatured alcohol, thymol, hydrogen peroxide, peroxy acids and combinations thereof.

3. The methodology for sanitizing a toothbrush of claim 1, wherein said at least one antibacterial component is selected from the group consisting of a non-necrotic fatty acid compound, a bis-biquanido hexane, a quaternary ammonium salt, an N-tetradecyl pyridium salt and an N-tetradecyl ethyl pyridium salt and combinations thereof.

4. The methodology for sanitizing a toothbrush of claim 1, wherein said flavoring additive is selected from the group consisting of oil of peppermint, oil of spearmint, oil of clove, oil of wintergreen, oil of cinnamon and combinations thereof.

5. The methodology for sanitizing a toothbrush of claim 1, wherein said flavoring additive is selected from the group consisting of oil of lemon, oil of almond, oil of nutmeg, oil of orange, oil of anise and combinations thereof.

6. The methodology for sanitizing a toothbrush of claim 1, wherein said flavoring additive is selected from the group consisting of oil of savory, oil of celery, oil of rosemary, oil of thyme, vanilla and combinations thereof.

7. The methodology for sanitizing a toothbrush of claim 1, wherein said flavoring additive is selected from the group consisting of lime, banana, cherry, brandy, rum and combinations thereof.

8. The methodology for sanitizing a toothbrush of claim 1, wherein said flavoring additive is selected from the group consisting of butterscotch, imitation brandy, synthetic vanilla, synthetic flavor and combinations thereof.

9. The methodology for sanitizing a toothbrush of claim 1, wherein there is about 10% to about 25% of said antibacterial agent.

10. The methodology for sanitizing a toothbrush of claim 1, wherein there is about 0.02% to about 4% by weight of said flavoring additive.

11. A methodology for sanitizing a toothbrush, which comprises:
(A.) providing a hand-held portable spray container, said spray container containing a solution comprising:
(a) water;
(b) a flavoring additive; and,
(c) about 0.5% to about 30% by weight of at least one antibacterial component.
(B.) spraying a toothbrush with an effective amount of said solution from said spray container.

12. The methodology for sanitizing a toothbrush of claim 1, wherein said at least one antibacterial component is selected from the group consisting of ethanol, denatured alcohol, thymol, hydrogen peroxide, peroxy acids and combinations thereof.

13. The methodology for sanitizing a toothbrush of claim 1, wherein said at least one antibacterial component is selected from the group consisting of a non-necrotic fatty acid compound, a bis-biquanido hexane, a quaternary ammonium salt, an N-tetradecyl pyridium salt and an N-tetradecyl ethyl pyridium salt and combinations thereof.

14. The methodology for sanitizing a toothbrush of claim 1, wherein said flavoring additive is selected from the group consisting of oil of peppermint, oil of spearmint, oil of clove, oil of wintergreen, oil of cinnamon and combinations thereof.

15. The methodology for sanitizing a toothbrush of claim 1, wherein said flavoring additive is selected from the group consisting of oil of lemon, oil of almond, oil of nutmeg, oil of orange, oil of anise and combinations thereof.

16. The methodology for sanitizing a toothbrush of claim 1, wherein said flavoring additive is selected from the group consisting of oil of savory, oil of celery, oil of rosemary, oil of thyme, vanilla and combinations thereof.

17. The methodology for sanitizing a toothbrush of claim 1, wherein said flavoring additive is selected from the group consisting of lime, banana, cherry, brandy, rum and combinations thereof.

18. The methodology for sanitizing a toothbrush of claim 1, wherein said flavoring additive is selected from the group consisting of butterscotch, imitation brandy, synthetic vanilla, synthetic flavor and combinations thereof.

19. The methodology for sanitizing a toothbrush of claim 1, wherein there is about 10% to about 25% of said antibacterial agent.

20. The methodology for sanitizing a toothbrush of claim 1, wherein there is about 0.02% to about 4% by weight of said flavoring additive.
